(19) United States
(12) Patent Application Publication
(10) Pub. No.: US 2011/0127150 A1
(43) Pub. Date: Jun. 2, 2011

(54) Jog key of portable terminal and operation method thereof

(75) Inventors: Jung Woo Lee, Seoul (KR); Sang Moon Ban, Yongin-si (KR)

(73) Assignee: Samsung Electronics Co., Ltd., Suwon-si (KR)

(21) Appl. No.: 12/928,022

(22) Filed: Dec. 1, 2010

(30) Foreign Application Priority Data
Dec. 1, 2009 (KR) 10-2009-0117829

(51) Int. Cl. H01H 3/04

(52) U.S. Cl. 200/332

(57) ABSTRACT

A jog key of a portable terminal and an operation method thereof. The portable terminal includes a jog key for inputting a direction signal, a push signal, or a pull signal. A storage unit stores a key map for mapping a specific function to an operation signal of the jog key. And a control unit senses an input of the operation signal of the jog key and executes a function mapped to the input operation signal of the jog key. This may provide various functions using a jog key to improve convenience of a user.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Dec. 1, 2009 and allocated Serial No. 10-2009-0117829, the contents of which are incorporated herein by reference.

### TECHNICAL FIELD OF THE INVENTION

The present invention relates to a jog key of a portable terminal and an operation method thereof, and more particularly, to a jog key of a portable terminal in which dome switches are respectively located at an upper part and a lower part of a housing, and an operation method thereof.

### BACKGROUND OF THE INVENTION

In recent years, with the rapid development of technology, a portable terminal has provided various additional functions such as a character message transmitting and receiving function, a photographing function, a music listening function, a digital broadcasting service function, an electronic-mail service function, and an instant messenger service function as well as a voice call function.

While portable terminals are trending towards miniaturization and slimming, the size of certain input devices is increasing. According to such a trend, a mounting space of an input device is insufficient in the portable terminal. That is, a conventional portable terminal cannot mount a number of key buttons. As the number of mountable key buttons is restricted, the conventional portable terminal provides only a function key for fundamental operation but cannot provide additional function keys for convenience for a user. Namely, the conventional portable terminal cannot provide various key maps. This can cause inconvenience in the use of a portable terminal while accessing various functions as mentioned above. Accordingly, there is a need for a method capable of providing various key maps in a portable terminal having an insufficient mounting space of a key button without adding separate key buttons.

### SUMMARY OF THE INVENTION

To address the above-discussed deficiencies of the prior art, it is a primary object to provide a jog key of a portable terminal capable of providing various key maps, and an operation method thereof.

In accordance with an aspect of the present invention, a jog key of a portable terminal includes a housing, a dome switch unit disposed at an inner lower side of the housing, and a dome switch unit disposed at an inner upper side of the housing. A lever is mounted in the housing and exposed to an outside. A pressure plate is integrally formed on the lever to extend from the lever to an inside of the housing. The pressure plate pressurizes at least one of the dome switch units according to movement of the lever.

In accordance with another aspect of the present invention, a portable terminal includes a jog key configured to input a direction signal, a push signal, and a pull signal. A storage unit stores a key map that maps a specific function to an operation signal of the jog key. And a control unit senses an input of the operation signal of the jog key and executes a function mapped to the input operation signal of the jog key.

In accordance with another aspect of the present invention, an operation method of a portable terminal includes inputting an operation signal of a jog key. The operation signal may be a direction signal, a push signal, or a pull signal. The method also includes searching a key map that maps a specific function to the input operation signal of the jog key. The method further includes executing the function mapped to the input operation signal of the jog key.

As described above, a jog key of a portable terminal and an operation method thereof according to the present invention may provide various key maps using a jog key to improve convenience of a user. Further, the present invention provides various key maps using a jog key. Accordingly, because space for adding separate function keys is unnecessary, the portable terminal can be miniaturized and slimmed. Since the present invention can configure various key maps without adding separate key buttons, the cost of the portable terminal can be reduced.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an appearance of a portable terminal according to an embodiment of the present invention;

FIG. 2a to FIG. 2c illustrate a structure and operation patterns of a jog key of a portable terminal according to an embodiment of the present invention;

FIG. 3 illustrates a schematic configuration of a portable terminal according to an embodiment of the present invention; and

FIG. 4 illustrates an operation method of a jog key of a portable terminal according to an embodiment of the present invention.

### DETAILED DESCRIPTION OF THE INVENTION

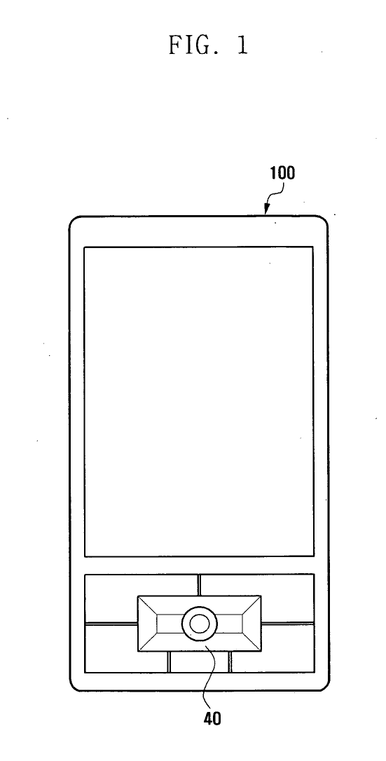

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. Detailed descriptions of well-known functions and structures incorporated herein may be omitted to avoid obscuring the subject matter of the present invention.

FIG. 1 is a view illustrating an appearance of a portable terminal 100 according to an embodiment of the present invention.

Prior to a detailed description, a dome switch is simply explained. When pressure is applied to the dome switch, an upper electrode comes in contact with a contact point circuit located at a lower part thereof to generate an electric signal. The dome switch is used for a button type input device. In recent years, since the dome switch is advantageous in that key click is excellent, duration is long, and a thickness is thin, it is widely used. A double dome switch capable of generating two signals has been used. In general, the double dome switch is mainly used for a shutter of a camera. That is, a user can adjust a focus through a half shutter input and then photograph a subject by a shutter input. Because the dome switch is apparent to a person having ordinary skill in the art to which the invention pertains, the detailed description thereof is omitted.

Referring to FIG. 1, the portable terminal 100 according to an embodiment of the present invention may include a jog key 40. The jog key 40 may provide a direction signal. Further, when a push occurs, the jog key 40 may provide a push signal. The jog key 40 according to an embodiment of the present invention may further provide a pull signal except for a direction signal and a push signal provided by a conventional jog key.

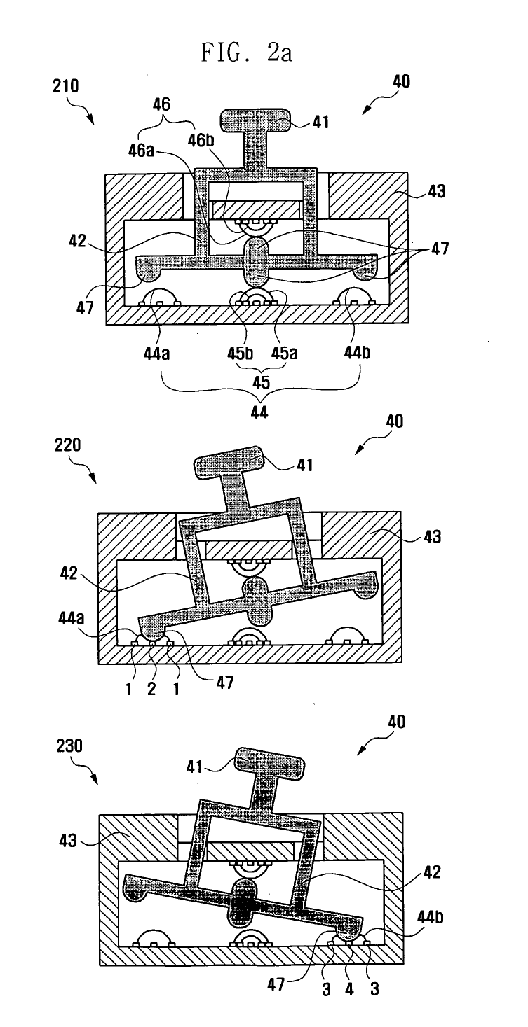

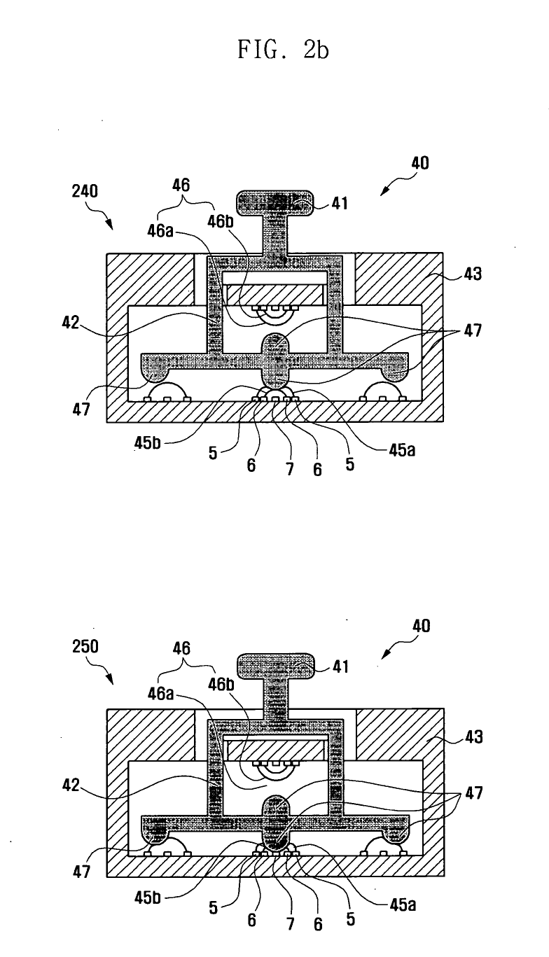

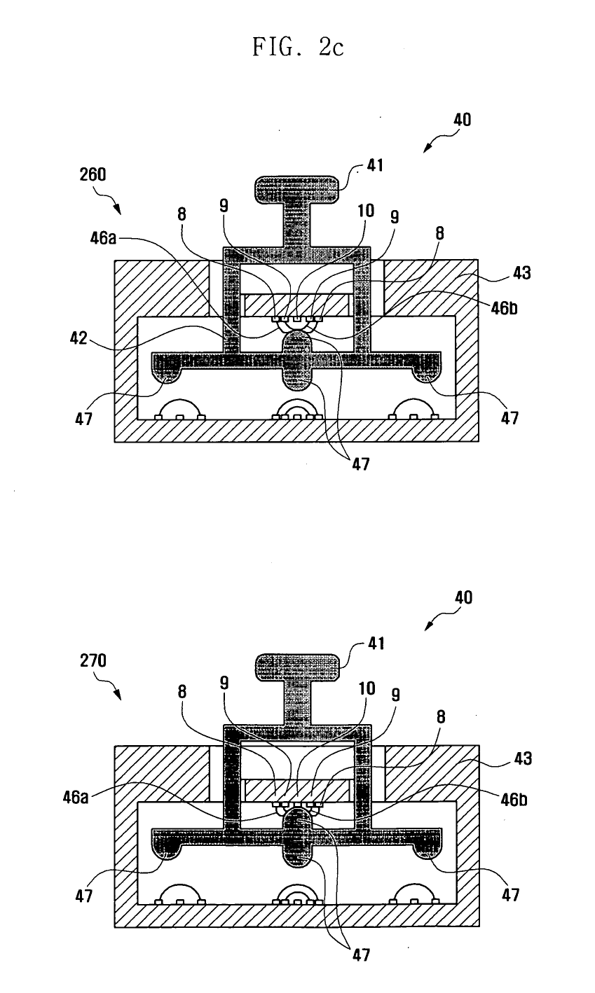

The jog key 40 of the portable terminal 100 according to an embodiment of the present invention includes a housing, a first dome switch unit, a second dome switch unit, a lever, and a pressure plate. The first dome switch unit is disposed at an inner lower side of the housing. The second dome switch unit is disposed at an inner upper side of the housing. The lever is mounted in the housing to expose to an outside. The pressure plate is integrally formed on the lever to extend from the lever to an inside of the housing, and pressurizes at least one of the first and second dome switch units according to movement of the lever. A dome switch is disposed at a lower end of the housing in the conventional jog key. Unlike the conventional jog key, the jog key 40 according to the present invention has a double structure that includes dome switch units disposed at upper and lower ends of the housing, respectively. Moreover, the jog key 40 can configure at least one of the dome switches providing a direction signal, a push signal, and a pull signal as a double dome switch. Accordingly, the jog key 40 according to the present invention may provide at least one of a direction signal, a push signal, a the pull signal as a double signal. A detailed structure of the jog key 40 according to an embodiment of the present is shown in FIG. 2a to FIG. 2c.

FIG. 2a to FIG. 2c are views schematically illustrating a structure of a jog key 40 of a portable terminal 100 according to an embodiment of the present invention.

Referring to FIG. 2a to FIG. 2c, the jog key 40 of the portable terminal 100 may include a lever 41, a pressure plate 42, a housing 43, a first dome switch unit 44, a second dome switch unit 45, and a third dome switch unit 46.

The housing 43 is a case enclosing the first dome switch unit 44, the second dome switch unit 45, and the third switch unit 46. The lever 41 is mounted in the housing 43 and is exposed to the outside. A user can input a direction signal, a push signal, a double push signal, a pull signal, and a double pull signal using the lever 41. The lever 41 moves to a specific direction by a user and returns to a position (center) before movement due to an elastic force of a dome switch.

The pressure plate 42 may be connected with the lever 41 to pressurize at least one of the first dome switch unit 44, the second dome switch unit 45, and the third dome switch unit 46. For example, when a user pushes the lever 41 in a left direction in a default state (state of no input signal) indicated by reference numeral 210 of FIG. 2a, the pressure plate 42 pressurizes a left dome switch 44a of the first dome switch unit 44 for generating a left signal. At this time, as illustrated by reference numeral 220 of FIG. 2a, a first electrode and a second electrode conduct by the left dome switch 44a to allow the jog key 40 to generate a left signal. Next, when the user removes a force pushing the lever 41 in a left direction, the pressure plate 41 returns to a default position, namely, a state indicated by reference numeral 210 of FIG. 2a due to an elastic force of the left dome switch 44a.

Further, when a user pushes the lever 41 in a right direction, the pressure plate 42 pressurizes a right dome switch 44b of the first dome switch unit 44 for generating a right signal. At this time, as illustrated by reference numeral 230 of FIG. 2a, a third electrode and a fourth electrode conduct by the right dome switch 44b to allow the jog key 40 to generate a right signal. Next, when the user removes a force pushing the lever 41 in a right direction, the pressure plate 42 returns to a default position, namely, a state indicated by reference numeral 210 of FIG. 2a due to an elastic force of the right dome switch 44b.

Furthermore, when the user pushes the lever 41 with a force ranging from a first reference magnitude to a second reference magnitude, the pressure plate 42 pressurizes the second dome switch unit 45. At this time, as illustrated by reference numeral 240 of FIG. 2b, a fifth electrode and a sixth electrode conduct by a first external dome switch 45a to allow the jog key 40 to generate a push signal. Next, when the user removes a force pushing the lever 41, the pressure plate 41 returns to a default position, namely, a state indicated by reference numeral 210 of FIG. 2a due to an elastic force of the first external dome switch 45a. When the user pushes the lever 41 with a force larger than the second reference magnitude, as illustrated by reference numeral 250 of FIG. 2b, the fifth electrode, the sixth electrode, and a seventh electrode conduct to allow the jog key 40 to generate a double push signal. Next, when the user removes a force pushing the lever 41, the pressure plate 42 returns to a default position, namely, a state indicated by reference numeral 210 of FIG. 2a due to elastic forces of the first external dome switch 45a and a first internal dome switch 45b.

Furthermore, when the user pulls the lever 41 with a force ranging from the first reference magnitude to the second reference magnitude, the pressure plate 42 pressurizes the third dome switch unit 46. At this time, as illustrated by reference numeral 260 of FIG. 2c, an eighth electrode and a ninth electrode conduct by a second external dome switch 46a to allow the jog key 40 to generate a pull signal. Subsequently, when the user removes a force pushing the lever 41, the pressure plate 41 returns to a default position, namely, a state indicated by reference numeral 210 of FIG. 2a due to an elastic force of the second external dome switch 46a. When the user pulls the lever 41 with a force larger than the second reference magnitude, as illustrated by reference numeral 270 of FIG. 2c, the eighth electrode, the ninth electrode, and a tenth electrode conduct to allow the jog key 40 to generate a double pull signal. Subsequently, when the user removes a force pushing the lever 41, the pressure plate 42 returns to a default position, namely, a state indicated by reference numeral 210 of FIG. 2a due to elastic forces of the second external dome switch 46a and a second internal dome switch 46b. The pressure plate 42 may include protrusion 47, which are provided at a part contacting with the first dome switch 44, the second dome switch 45, and the third dome switch unit 46.

The first dome switch unit 44 may include a plurality of dome switches for inputting direction signals. For example, the first dome switch unit 44 may include four dome switches for recognizing up, down, left and right signals, respectively. Namely, the first dome switch unit 44 may include a left dome switch 44a inputting a left signal, a right dome switch 44b inputting a right signal, an up dome switch (not shown) inputting an up signal, and a down switch (not shown) inputting a down signal. A general dome switch inputting one signal is shown in FIG. 2a to FIG. 2c as the first dome switch 44. However, a double dome switch inputting two signals can be configured by the first dome switch 44.

The second dome switch unit 45 can input a push signal in the control unit 110. In an embodiment, the second dome switch unit 45 according to the present invention may be configured with a double dome switch to input a double push signal in the control unit 110. Namely, when the user pushes a lever 41 with a force ranging from a first reference magnitude to a second reference magnitude, a first external dome switch 45a of the second dome switch unit 45 is pushed to generate a push signal. In the meantime, when the user pushes the lever 41 with a force larger than the second reference magnitude, the first external dome switch 45a and a first internal dome switch 45b are pushed to generate a double push signal.

The third dome switch unit 46 can input a pull signal in the control unit 110. In an embodiment, the third dome switch unit 46 according to the present invention may be configured by a double dome switch to input a double pull signal in the control unit 110. That is, when the user pulls the lever 41 with a force ranging from the first reference magnitude to the second reference magnitude, a second external dome switch 46a of the third dome switch unit 46 is pressed to generate a pull signal. The user pulls the lever 41 with a force larger than the second reference magnitude to press the second external dome switch 46a and a second internal dome switch 46b, thereby generating a double pull signal.

Although not shown in FIG. 2a to FIG. 2c, the jog key 40 may further include an elastic material returning the lever 41 moved to a specific direction to an original position (center) before movement, and a support member supporting the elastic material. Since a detailed structure of the elastic material and support member does not relate to a gist of the present invention, a detailed description thereof is omitted.

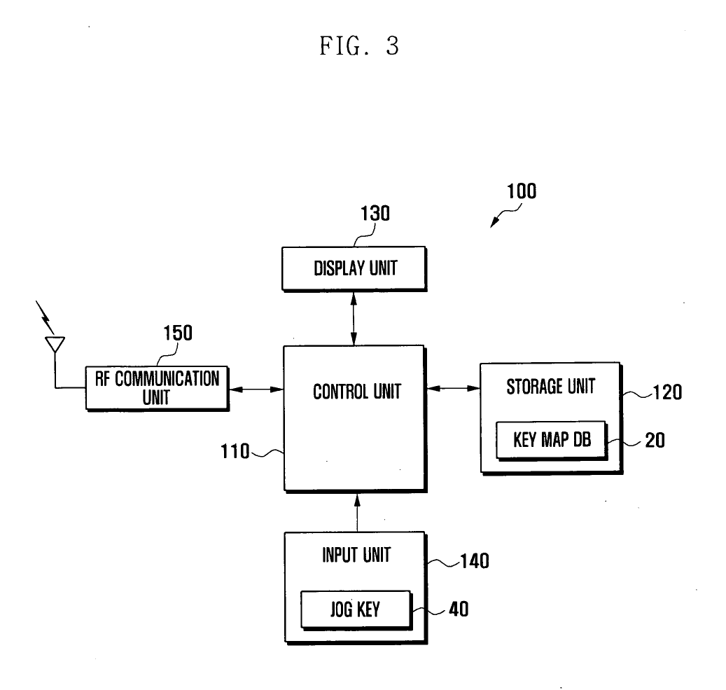

FIG. 3 is a block diagram illustrating a schematic configuration of a portable terminal according to an embodiment of the present invention.

Referring to FIG. 3, a portable terminal according to an embodiment of the present invention includes a radio frequency (RF) communication unit 150, an input unit 140, a display unit 130, a storage unit 120, and a control unit 110. The storage unit 120 may include a key map database (DB) 20.

The input unit 140 may receive input of numerals or various character information, and include input keys and function keys for controlling functions of the portable terminal 100. For example, the input unit 140 may include a call key for requesting a voice call, a video phone call key for requesting a video phone call, a termination key for requesting termination of the voice call or the video phone call, and a volume key capable of controlling an output volume of an audio signal. In an embodiment, the input unit 140 according to the present invention may include a jog key 40. As illustrated referring to FIG. 2a to FIG. 2c, the jog key 40 may input the direction signal, the push signal, and the pull signal. Further, the jog key 40 may input a double push signal and a double pull signal.

The RF communication unit 150 exchanges an RF signal with a mobile communication network. The RF communication unit 150 may include a RF transmitter (not shown) up-converting a frequency of a transmitted signal and amplifying the signal, and an RF receiver (not shown) low-noise-amplifying a received signal and down-converting the signal. In an embodiment, the RF communication unit 150 according to the present invention may receive a web page from a web server (not shown). The RF communication unit 150 may transmit a signal requesting an output of a previous web page when a pull signal of the jog key 40 is generated while a web page is output under control of the control unit 110. Moreover, the RF communication unit 150 may transmit a signal requesting a linked web page and receive a web page from the web server when a push signal of the jog key 40 is generated while a pointer is located at a linked area of a specific web page.

The display unit 130 may display user data and function setting information input by a user, and various information provided to the user as well as various types of menu screens of the portable terminal 100. For example, the display unit 130 may output a booting screen, an idle screen, a menu screen, a video phone call screen, and a web page. In an embodiment, the display unit 130 according to the present invention may output a scrolled web page, a zoomed-in web page, or a zoomed-out web page according to an operation signal of the jog key 40. Moreover, the display unit 130 may move and output a pointer according to the operation signal of the jog key 40. In addition, when a pull signal of the jog key 40 is generated, the display unit 130 may output a screen of a previous web page. The display unit 130 can be configured by a Liquid Crystal Display (LCD), an Organic Light Emitting Diode (OLED), or an Active Matrix Organic Light Emitting Diode (AMOLED). When the display unit 130 is configured by a touch-screen form, it can operate as the input unit 140.

The storage unit 120 may store an operating system (OS) of a portable terminal 100 according to an embodiment of the present invention, application programs necessary for options functions such as a voice play function, an image or moving image play function, or a broadcast play function, user data and data transmitted or received at the time of communication. In an embodiment, the storage unit 120 according to the present invention may store a key map mapping a specific function to the operation signal of the jog key 40. For example, the storage unit 120 may store a key map listed in table 1.

TABLE 1

| Operation signal of jog key | Function |
|---|---|
| Push signal | Confirmation |
| Pull signal | Backward |
| Double push signal | Zoom-in |
| Double pull signal | Zoom-out |
| up signal | upward movement of pointer |
| down signal | downward movement of pointer |
| Left signal | Left movement of pointer |
| Right signal | Right movement of pointer |

Referring to Table 1, a moving function of a pointer indicating at the time of outputting a web page may be mapped to a direction signal of the jog key 40. A moving function to a previous web page may be mapped to a pull signal. A reduction (zoom-out) function of a web page may be mapped to a double pull signal. An enlargement (zoom-in) function of a web page may be mapped to a double push signal. A confirmation function may be mapped to a push signal of the jog key 40. For example, when a pull signal is generated while a pointer is located in a set area of a link of a specific web page, a linked web page can be output on a display unit 130. Furthermore, although not illustrated in Table 1, a moving (scroll) function of a web page may be mapped to a direction signal occurring in a pushed state. As described previously, the present invention may execute various functions using the jog key 40 to improve convenience of web surfing.

Table 1 illustrates one example of a key map in the jog key 40. However, the present invention is not limited thereto. Namely, a function mapped to the operation signal of the jog key 40 can be variously changed according to a designer's intention. Further, the key map of the jog key 40 can be differently set according to an output mode (e.g., a multi-media play mode, a camera photographing mode, a web page output mode, an idle screen output mode, and the like). To do this, the storage unit 120 may include a key map database (DB) 20 storing a key map by modes. The storage unit 120 may include a menu capable of mapping a specific function to an operation signal of the jog key 40 according to a user's taste.

The control unit 110 may control an overall operation and signal flow between internal blocks of the portable terminal 100, and include a function of a data processor processing data transmitted and received through the RF communication unit 150. In an embodiment, the control unit 110 according to the present invention may receive an operation signal of the jog key 40 and execute a function mapped to the received operation signal. For example, when the direction signal is input, the control unit 110 executes a direction key function. When a double push signal is input, the control unit 110 executes a zoom-in function. When a double pull signal is input, the control unit 110 executes a zoom-out function. When the direction signal is input in a pushed state, the control unit 110 executes a scroll function. At this time, the function mapped to the operation signal may be differently set according to a current mode (e.g., web page output mode, multi-media play mode, camera photographing mode, idle screen output mode, and the like) of the portable terminal 100. In this situation, when the operation signal of the jog key 40 is input, the control unit 110 may search the key map DB 20.

Here, an operation of the control unit 110 is described by way of example when a web page is output. When a pull signal of the jog key 40 is input, the control unit 110 can execute a backward function moving to a previous web page. When a double pull signal is input, the control unit 110 may execute a zoom-in function enlarging and outputting a web page. When a double push signal is input, the control unit 110 may execute a zoom-out function reducing and outputting the web page. Further, when a push signal is input, the control unit 110 may execute a confirmation key function. For example, when a push signal is input while a pointer is located at a linked area (image, icon, text, and the like) of a specific web page, the control unit 110 may control the display unit 130 to output the linked web page. Moreover, when a direction signal is input in a pushed state, the control unit 110 may control the display unit 130 to move (scroll) and output the web page. The present invention may execute zoom-in/zoom-out functions, a backward function, and a scroll function using the jog key 40 without using a separate input device to improve convenience of web surfing.

Although not shown, the portable terminal 100 may include structural elements having additional functions such as a camera module for photographing images or moving images, a near distance communication module for near distance wireless communication, a broadcasting receiving module for receiving broadcast, a digital sound source play module such as an MP3 module, an Internet communication module executing an Internet function. Since the structural elements can be variously changed according to convergence trend of a digital device, all the elements are not listed. However, the portable terminal 100 may further include structural elements equivalent to the foregoing structural elements.

The portable terminal according to an embodiment of the present invention has been described previously. Hereinafter, an operation method of a jog key 40 of the portable terminal 100 will be described.

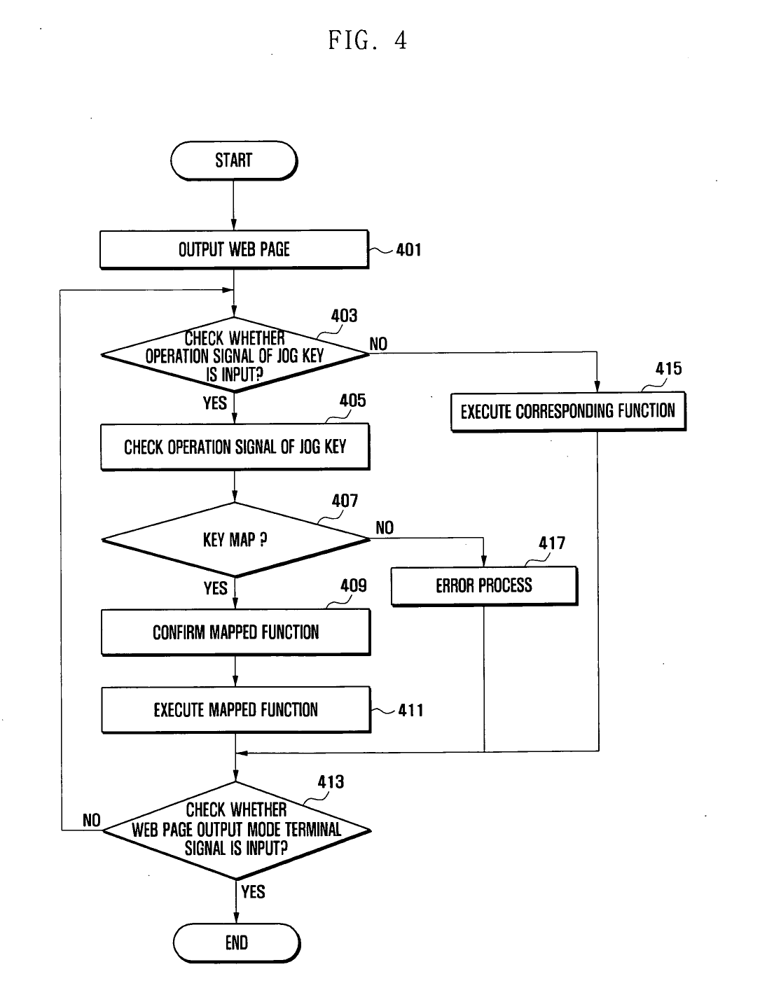

FIG. 4 illustrates an operation method of a jog key of a portable terminal according to an embodiment of the present invention.

Prior to a detailed description, an operation method of a jog key 40 of a portable terminal will be described in a web page output mode outputting a web page by way of example. However, the present invention is not limited to an embodiment using a jog key 40 in the web page output mode. For example, the present invention may use the jog key 40 in various modes (moving image play mode, camera photographing mode, album view mode, and idle screen output mode).

Referring to FIG. 4, the control unit 110 may output a specific web page according to a user request (block 401). Next, the control unit 110 may check whether an operation signal of a jog key 40 is input (block 403). When the operation signal of the jog key 40 is not input, the control unit 110 may execute a corresponding function (block 415). For example, the control unit 110 may execute a function corresponding to a key input signal of an input unit 140 other than the jog key 40.

Conversely, when the operation signal of the jog key 40 is input, the control unit 110 can check the operation signal of the jog key 40 (block 405). Namely, the control unit 110 can check whether the input operation signal of the jog key 40 is a push signal, a pull signal, or a direction signal.

Subsequently, the control unit 110 may identify whether the checked operation signal of the jog key 40 is included in a key map DB 20 (block 407). To do this, the control unit 110 may search a key map DB 20 stored in a storage unit 120. When the identified operation signal of the jog key 40 is not included in the key map DB 20, the control unit 110 performs an error process (block 417). For example, the control unit 110 may output a message indicating that there is no mapped function on a display unit 130. Otherwise, the control unit 110 may maintain a current screen state without executing a separate function. Next, the control unit 110 may go to block 413.

Conversely, when the operation signal of the jog key 40 is included in the key map DB 20, the control unit 110 may confirm a function mapped to the input operation signal of the jog key 40 (block 409), and execute the mapped function (block 411). For example, as illustrated in Table 1, when the operation signal of the jog key 40 is a direction signal, the control unit 110 moves a pointer according to the direction signal. When the operation signal of the jog key 40 is a pull signal, the control unit 110 moves the pointer to a previous web page. When the operation signal of the jog key 40 is a double pull signal, the control unit 110 may reduce (zoom-out) and output a web page. When the operation signal of the jog key 40 is a double push signal, the control unit 110 may enlarge (zoom-in) and output the web page. Further, when a push signal is generated while a pointer is located at a link setting area, the control unit 110 controls a linked web page to be output. When a direction signal is input in a pushed state, the control unit 110 moves (scrolls) and outputs the web page on the display unit 130 according to the input direction signal.

Subsequently, the control unit 110 may check whether a web page output mode terminal signal is input (block 413). When the web page output mode terminal signal is input, the control unit 110 terminates a web page output mode. When the web page output mode terminal signal is not input, the control unit 110 returns to block 403 and repeats the foregoing procedures.

As described above, the present invention may provide various key maps using a jog key to improve convenience of a user. Because a space adding separate function keys is unnecessary as the present invention provides various key maps using a jog key, the portable terminal can be miniaturized and slimmed. Since the present invention can provide various key maps without adding separate key buttons, the cost of a portable terminal can be reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A jog key of a portable terminal, comprising:
a housing;
a dome switch unit disposed at an inner lower side of the housing;
a dome switch unit disposed at an inner upper side of the housing;
a lever mounted in the housing and exposed to an outside; and
a pressure plate integrally formed on the lever to extend from the lever to an inside of the housing, the pressure plate configured to pressurize at least one of the dome switch units according to movement of the lever.

2. The jog key of claim 1, wherein at least one of the dome switch units is a double dome switch.

3. The jog key of claim 1, further comprising an elastic material configured to return the lever to an original position before movement.

4. The jog key of claim 1, wherein the pressure plate comprises protrusions configured to contact at least one of the dome switch units.

5. The jog key of claim 1, wherein the dome switch unit disposed at an inner lower side of the housing comprises a first dome switch unit configured to input the direction signal and a second dome switch unit configured to input the push signal; and the dome switch unit disposed at an inner upper side of the housing comprises a third dome switch unit configured to input the pull signal.

6. A portable terminal, comprising:
a jog key configured to input a direction signal, a push signal, and a pull signal;
a storage unit configured to store a key map that maps a specific function to an operation signal of the jog key; and
a control unit configured to sense an input of the operation signal of the jog key, and execute a function mapped to the input operation signal of the jog key.

7. The portable terminal of claim 6, wherein the jog key comprises:
a first dome switch unit configured to input the direction signal;
a second dome switch unit configured to input the push signal; and
a third dome switch unit configured to input the pull signal.

8. The portable terminal of claim 7, wherein at least one of the first dome switch unit, the second dome switch unit, and the third dome switch unit is a double dome switch.

9. The portable terminal of claim 6, wherein the storage unit comprises a key map database configured to store the key map by modes of the portable terminal, the modes comprising a web page output mode, a multi-media play mode, a camera photographing mode, a text view mode, and an idle screen output mode.

10. The portable terminal of claim 8, wherein the control unit executes a direction key function when the direction signal is input.

11. The portable terminal of claim 8, wherein the control unit executes a zoom-in function when a double push signal is input, and executes a zoom-out function when a double pull signal is input.

12. The portable terminal of claim 8, wherein the control unit executes a scroll function according to the direction signal when the direction signal is input in an input state of the push signal.

13. An operation method of a portable terminal, comprising:
inputting an operation signal of a jog key, the operation signal being one of a group of operation signals comprising a direction signal, a push signal, and a pull signal;
searching a key map that maps a specific function to the input operation signal of the jog key; and
executing the function mapped to the input operation signal of the jog key.

14. The method of claim 13, wherein the operation signal of the jog key further comprises a double pull signal and a double push signal.

15. The method of claim 14, wherein executing the function comprises executing a pointer moving function corresponding to the input direction signal when the direction signal is input in an output state of a specific web page.

16. The method of claim 14, wherein executing the function comprises executing a backward function outputting a previous web page when the pull signal is input.

17. The method of claim 14, wherein executing the function comprises executing a zoom-out function when the double pull signal is input.

18. The method of claim 14, wherein executing the function comprises executing a confirmation key function when the push signal is input.

19. The method of claim 14, wherein executing the function comprises executing a zoom-in function when the double push signal is input.

20. The method of claim 14, wherein executing the function comprises executing a scroll function of the specific web page corresponding to a direction signal when the push signal and the direction signal are simultaneously input.
